(19) United States
(12) Patent Application Publication
(10) Pub. No.: US 2017/0207563 A1
(43) Pub. Date: Jul. 20, 2017

(54) HERMAPHRODITIC TERMINAL

(71) Applicant: J.S.T. CORPORATION, Farmington Hills, MI (US)

(72) Inventors: Ryan DOMBROWSKI, Ann Arbor, MI (US); Franklin A. HOLUB, West Bloomfield, MI (US)

(73) Assignee: J.S.T. CORPORATION, Farmington Hills, MI (US)

(21) Appl. No.: 15/381,356

(22) Filed: Dec. 16, 2016

Related U.S. Application Data
(60) Provisional application No. 62/279,099, filed on Jan. 15, 2016.

(51) Int. Cl. H01R 13/28; H01R 4/18

(52) U.S. Cl. CPC H01R 13/28; H01R 4/185

(57) ABSTRACT

An electrical terminal having walls defining a receptacle section with a hollow interior and a blade elastically connected to the bottom wall of the receptacle section, the blade being oriented parallel to the long dimension of the receptacle section and extending out of the open end of the receptacle section. The blade is elastically biased and elastically compressible such that two of the electrical terminals can be connected hermaphroditically facing each other rotated 180° around the connection axis, with the blade of each terminal inserted into the receptacle section of the other terminal. The electrical terminal can be used in automobiles.

### BACKGROUND OF THE INVENTION

Field of the Invention

The present invention is in the field of electrical connectors, and in particular relates to hermaphroditic/genderless electrical connectors that mate at 180° around the longitudinal axis to another of the same connector.

Description of the Related Art

Hermaphroditic electrical terminals have the property that two identical terminals can mate with each other, when oriented to face each other on and rotated 180° around the longitudinal axis. Hermaphroditic terminals can save manufacturing costs since only one kind of terminal, rather than separate male and female terminals, can be used.

An exemplary hermaphroditic electrical terminal is seen in U.S. Pat. No. 5,266,046 to Bogiel, in which each terminal has a front mating end and a rear conductor connecting end. The front terminal mating end includes forwardly extending spaced-apart contact arms and a generally planar contact blade. The contact blade of each terminal is adapted to be slidingly received between the contact arms of the other terminal.

### BRIEF SUMMARY OF THE INVENTION

The present invention is a hermaphroditic electrical terminal having a receptacle section having a top wall, a first side wall, a second side wall and a bottom wall, oriented in a rectangular box shape. This defines a long dimension of the receptacle section. The walls of the receptacle section define a hollow interior of the receptacle section and the receptacle section has an open end. There is a blade elastically connected to the bottom wall of the receptacle section, the blade being oriented parallel to the long dimension of the receptacle section and extending out of the open end of the receptacle section. The blade comprises a raised contact surface on the side of the blade facing the top wall, and the blade is elastically biased toward the top wall, such that the raised contact surface is located more than one-half of the interior distance toward the top wall. There is a crimp portion connected to the end of the receptacle section opposite the open end, for connecting the terminal to a cable.

The terminal may have a primary terminal lock for locking the terminal to a connector holding the terminal. The terminal may also have a terminal polarization portion.

The terminal of the invention may be made from a single sheet of metal, may be made of copper or brass, and may have a surface finish of tin, silver or gold on the walls.

### BRIEF DESCRIPTION OF THE SEVERAL VIEWS OF THE DRAWING

FIG. 1 is a perspective view of one embodiment of the hermaphroditic terminal of the invention.

FIG. 2 is another perspective view of the hermaphroditic terminal of FIG. 1, in which the terminal is rotated 180° around the longitudinal axis.

FIG. 3A is a perspective view of two of the hermaphroditic terminals of the invention oriented so that they can be mated to each other.

FIG. 3B is a perspective view of two of the hermaphroditic terminals of the invention mated to each other.

FIG. 4A is a top plan view of two of the hermaphroditic terminals of the invention mated to each other.

FIG. 4B is a longitudinal cross-sectional view of two mated hermaphroditic terminals of FIG. 4A along the indicated cross-section line.

FIG. 5 is a perspective view of another embodiment of the hermaphroditic terminal of the invention.

FIG. 6 is a plan view of a cut metal sheet that can be folded to form the hermaphroditic terminal of the invention.

### DETAILED DESCRIPTION OF THE INVENTION

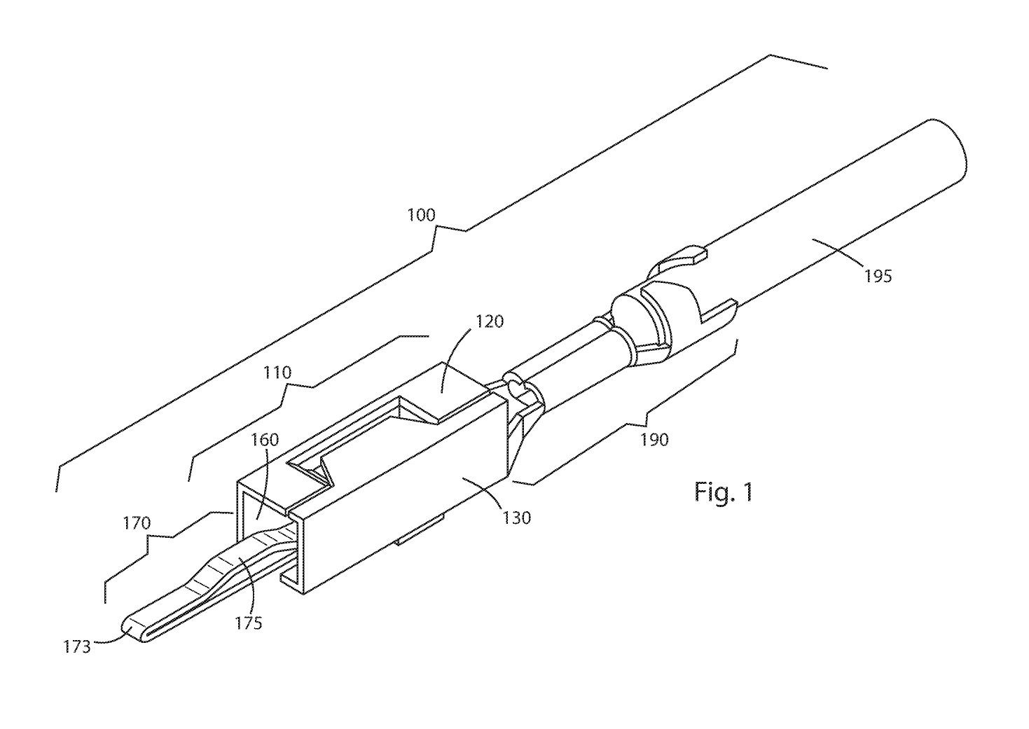

One embodiment of the hermaphroditic terminal of the invention is seen in FIG. 1. In FIG. 1, hermaphroditic terminal 100 has a receptacle section 110. The receptacle section 110 has a top wall 120, a first side wall 130, a second side wall 140 and a bottom wall 150, oriented in a rectangular box shape. The rectangular shape of the walls and of the receptacle section defines a long dimension of the terminal. The walls of the receptacle section define a hollow interior of the receptacle section and the receptacle section has an open end 160.

There is a blade 170 elastically connected to the bottom wall of the receptacle section and oriented parallel to the long dimension of the receptacle section 110. The blade 170 extends out of the open end 160 of the receptacle section 110. The blade 170 is generally flat at the tip 173, and the blade has a raised contact surface 175 on the side of the blade facing the top wall. The blade is elastically biased toward the top wall 120, such that the raised contact surface 175 is located more than one-half of the interior distance toward the top wall 120 when the terminal is not mated to another terminal. This elastic biasing provides pressure against the corresponding blade of a second hermaphroditic terminal, when the two terminals are mated, as explained further below.

There is a crimp portion 190 connected to the opposite end of the receptacle section opposite open end 160. This crimp portion can be crimped to hold a cable 195 and its wire, providing an electrical and mechanical connection from the wire to the hermaphroditic terminal.

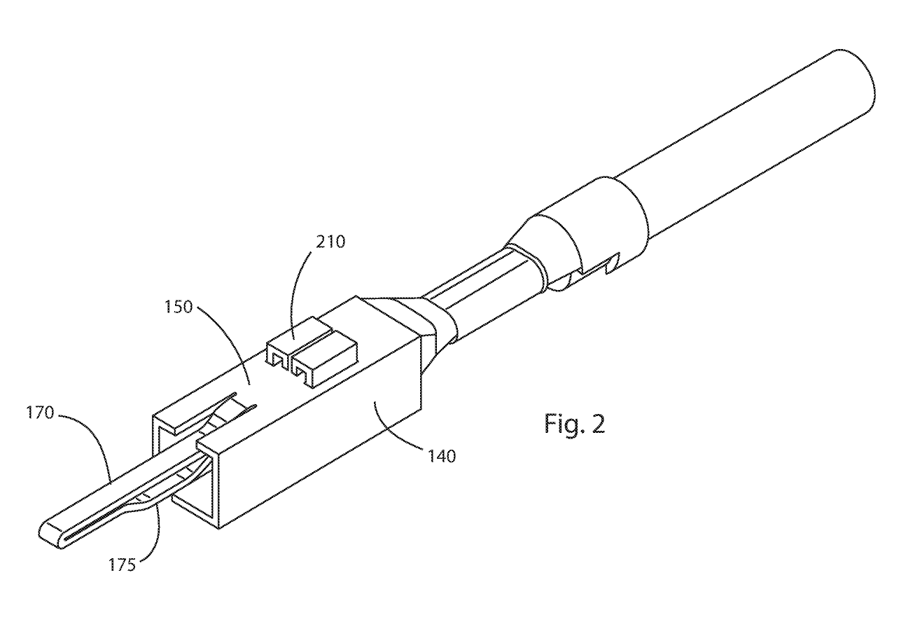

FIG. 2 is another perspective view of the terminal shown in FIG. 1, in which the terminal is rotated 180° around the longitudinal axis relative to the orientation in FIG. 1. In FIG. 2, the attachment of blade 170 to bottom wall 150 can be seen, as well as the arrangement of the blade to be biased toward the top wall 120.

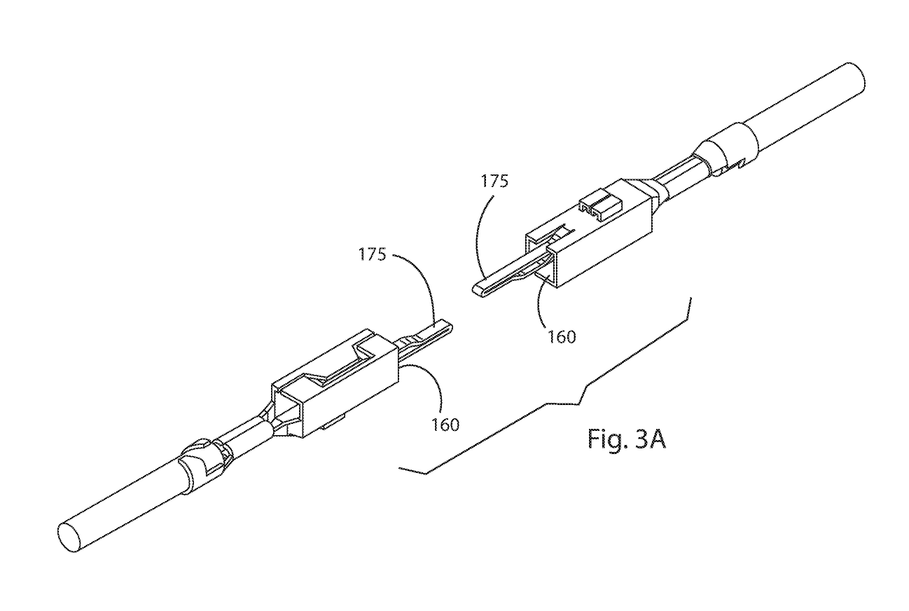

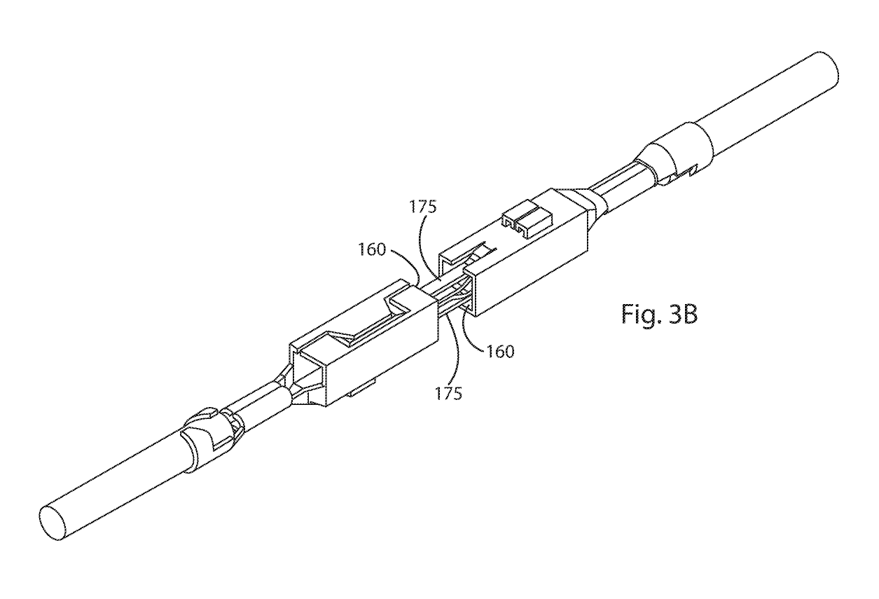

Two units of the hermaphroditic terminal can be mated by being oriented as shown in FIG. 3A and then pushed toward each other such that the blade 170 of each terminal enters the open end 160 of the other terminal. FIG. 3B illustrates two terminals after being mated.

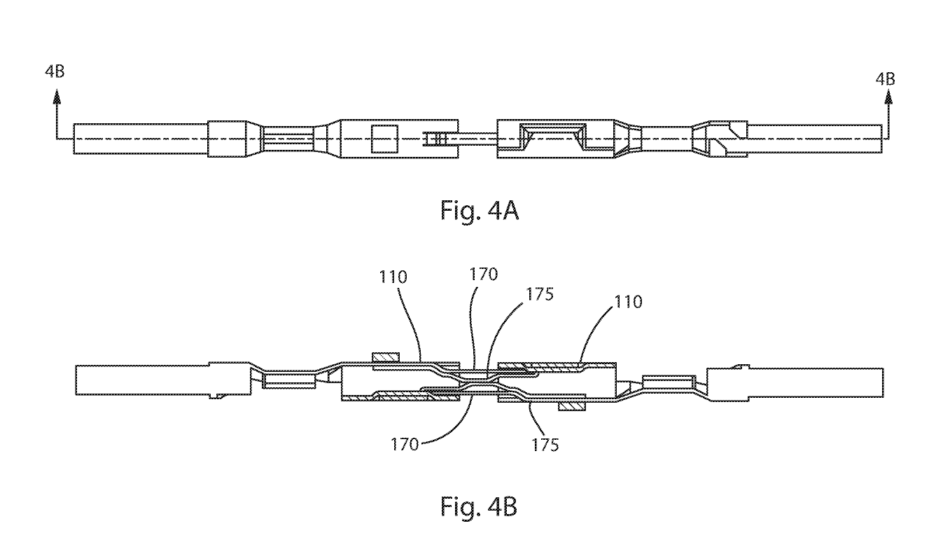

The structure of two mated terminals of the invention can be seen with reference to FIGS. 4A and 4B, which are plan and cross-sectional views, respectively, of two mated terminals. As can be seen in FIG. 4B, raised contact surfaces 175 of the two terminals are pressed against one another. This elastic biasing of the blades 170 relative to their receptacle sections 110 presses the raised contact surfaces together when the two terminals are mated.

In another embodiment of the invention, the raised contact surface 175 of the blade 170 is spring-like and elastically resists compression against the lower part of blade 170. This also serves to provide pressure of the two raised contact surfaces 175 when two terminals are mated to each other. Typically, when mated, the majority of the deformation should be seen in the compression of the raised contact surface of the blade.

In the embodiment of the invention shown in FIG. 1, there is a terminal primary lock 135 on the first side wall 130. The terminal primary lock serves to lock the terminal into a connector unit designed to hold one or more of the terminals. The terminal primary lock is optional.

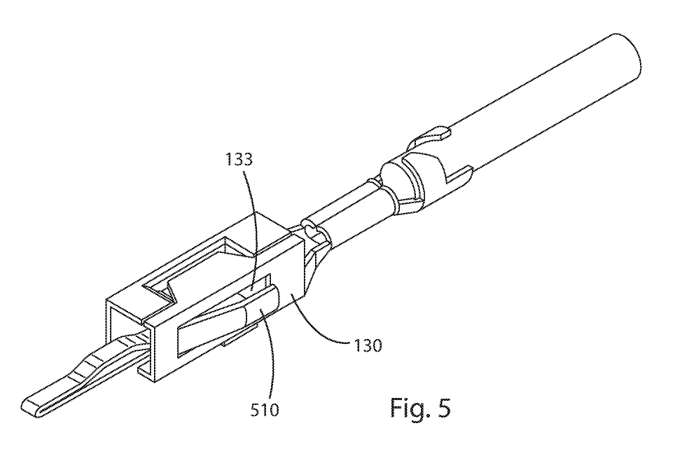

There is optionally a terminal primary lock on the first side wall 130. In the embodiment of the invention seen in FIG. 5, the terminal primary lock is in the form of retention tab 510 connected to the first side wall 130. The first side wall 130 has a slot 133 and the retention tab 510 is connected to the first side wall at an edge of the slot. The retention tab is elastically biased to be in the region exterior to the slot 133, and when the retention tab is pressed, the retention tab enters the slot. This arrangement allows the terminal to be inserted into a connector unit connector unit designed to hold one or more of the terminals, and to lock the terminal into the connector unit.

As seen in FIG. 2, in one embodiment of the invention, the receptacle section 110 has a terminal polarization section 210 one of the walls. In FIG. 2, the terminal polarization section is on the bottom wall.

The hermaphroditic terminal of the invention is typically made of metal, and may be made of a single piece of metal. The metal may be copper or brass and the walls of the electrical terminal may have a surface finish of tin, silver or gold.

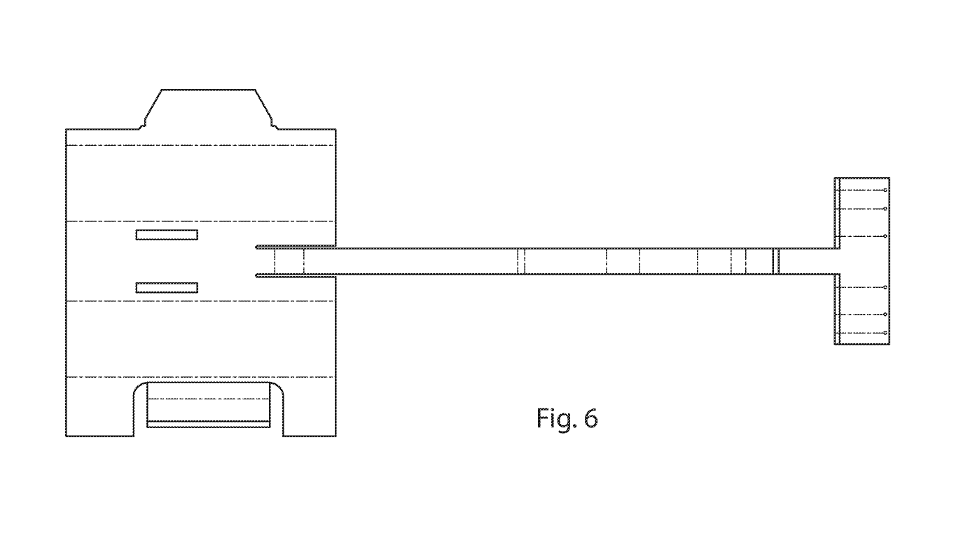

The hermaphroditic electrical terminal may be made by folding a single piece of metal. An example of a cut sheet of metal that can be folded to form the hermaphroditic terminal of FIG. 1 is shown in FIG. 6.

The hermaphroditic terminal of the invention may be used in many different applications; requiring an electrical connector, for example, in automotive applications.

It will be understood that the present invention is not limited to the above-described embodiments and that the present description embodies various modifications in design, structural arrangement or the like within the scope and equivalents of the present invention.

### LIST OF REFERENCE NUMERALS

100 Hermaphroditic terminal

110 Receptacle section

120 Top wall

130 First side wall

133 Slot

140 Second side wall

150 Bottom wall

160 Open end

170 Blade

173 Tip of blade

175 Raised contact surface

190 Crimp portion

195 Cable

210 Terminal polarization portion

510 Retention tab

What is claimed is:

1. An electrical terminal, comprising:
a receptacle section having a top wall, a first side wall, a second side wall and a bottom wall, oriented in a rectangular box shape, the receptacle section having a long dimension;
wherein the walls of the receptacle section define a hollow interior of the receptacle section and the receptacle section has an open end;
a blade elastically connected to the bottom wall of the receptacle section, the blade being oriented parallel to the long dimension of the receptacle section and extending out of the open end of the receptacle section;
wherein the blade comprises a raised contact surface on the side of the blade facing the top wall;
wherein the blade is elastically biased toward the top wall, such that the raised contact surface is located more than one-half of the interior distance toward the top wall; and
a crimp portion connected to the end of the receptacle section opposite the open end.

2. The electrical terminal of claim 1, wherein:
the first side wall has a terminal primary lock connected to the first side wall.

3. The electrical terminal of claim 1, wherein:
the first side wall comprises two overlapping layers.

4. The electrical terminal of claim 1, further comprising:
a cable having a wire, the wire being crimped by the crimp portion.

5. The electrical terminal of claim 4, wherein:
said wire is in the size range of 22 AWG to 12 AWG.

6. The electrical terminal of claim 1, wherein:
the blade is shaped so as to be elastically compressible in the thickness direction of the blade, such that the blade can be compressed to an overall thickness of one-half of the interior distance between the bottom and the top wall.

7. The electrical terminal of claim 1, wherein:
the electrical terminal is made from a single piece of metal.

8. The electrical terminal of claim 7, wherein:
the electrical terminal is made from a stamped sheet of metal that is folded to form the electrical terminal.

9. The electrical terminal of claim 1, further comprising:
a terminal polarization unit on the exterior of one of the walls of the electrical terminal.

10. The electrical terminal of claim 1, wherein:
the electrical terminal is made from copper or brass.

11. The electrical terminal of claim 10, further comprising:
a surface finish of tin, silver or gold on the walls of the electrical terminal.

12. The electrical terminal of claim 1, wherein:
the first side wall has a slot and has a retention tab connected to the first side wall at an edge of the slot, wherein the retention tab is elastically biased to be in the region exterior to the slot, such that when the retention tab is pressed the retention tab enters the slot.
